(19) United States
(12) Patent Application Publication
(10) Pub. No.: US 2018/0152319 A1
(43) Pub. Date: May 31, 2018

(54) Well Construction Site Communications Network

(71) Applicant: Schlumberger Technology Corporation, Sugar Land, TX (US)

(72) Inventors: Juan Jose Rojas, Katy, TX (US); Njål Aarsland, Kristiansand (NO)

(21) Appl. No.: 15/361,781

(22) Filed: Nov. 28, 2016

(51) Int. Cl. H04L 12/46; H04L 12/66; H04L 12/40; E21B 41/00

(52) U.S. Cl. CPC H04L 12/4641; H04L 12/66; E21B 41/0092; H04L 12/4637; H04L 12/40

(57) ABSTRACT

Apparatus including, and methods of operating a communications network having a common data bus communicatively coupled to control devices, non-control devices, and network appliances. The control devices control corresponding equipment components of a well construction system. One of the network appliances implements a gateway disposed between the common data bus and a corresponding control device and/or non-control device to translate communications to a common protocol for transmission on the common data bus. One of the network appliances implements a firewall disposed between the common data bus and a corresponding non-control device to permit or prohibit communications to be transmitted to the common data bus.

### BACKGROUND OF THE DISCLOSURE

In the drilling of oil and gas wells, drilling rigs are used to create a well by drilling a wellbore into a formation to reach oil and gas deposits (e.g., hydrocarbon deposits). During the drilling process, as the depth of the wellbore increases, so does the length and weight of the drillstring. A drillstring may include sections of drill pipe, a bottom hole assembly, and other tools for creating a well. The length of the drillstring may be increased by adding additional sections of drill pipe as the depth of the wellbore increases. Various components of a drilling rig can be used to advance the drillstring into the formation.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus that includes a communications network having a common data bus communicatively coupled to control devices, non-control devices, and network appliances. The control devices are able to control corresponding equipment components of a well construction system. One of the network appliances implements a gateway. The gateway is disposed between the common data bus and a corresponding control device and/or non-control device to translate communications to a common protocol for transmission on the common data bus. One of the network appliances implements a firewall. The firewall is disposed between the common data bus and a corresponding non-control device to permit or prohibit communications to be transmitted to the common data bus.

The present disclosure also introduces an apparatus that includes equipment controllers, non-control devices, and a physical network. The equipment controllers each control operation of corresponding well construction equipment components. The non-control devices are not operable to control operation of well construction equipment. The physical network includes network appliances communicatively coupled to the equipment controllers and the non-control devices. The physical network includes a common data bus. A gateway implemented via one of the network appliances translates communications to a common protocol for transmission on the common data bus. The equipment controllers and the non-control devices are each communicatively coupled with the common data bus via the gateway. A firewall implemented via one of the network appliances controls which communications are transmitted to the common data bus. The non-control devices are each communicatively coupled with the common data bus via the firewall. No firewall is communicatively disposed between the common data bus and the equipment controllers.

The present disclosure also introduces a method that includes operating a communications network. The communications network includes a common data bus communicatively coupled to network appliances, non-control devices, and control devices. The control devices at least partially control corresponding components of equipment of a well construction system. Operating the communications network includes operating a gateway on one of the network appliances, including translating communications from the control devices and non-control devices to a common protocol and transmitting the translated communications towards the common data bus. Operating the communications network also includes operating a firewall on one of the network appliances, including determining whether to permit communications from the non-control devices to be transmitted to the common data bus and transmitting the permitted communications towards the common data bus.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals in the various examples. This repetition is for simplicity and clarity, and does not in itself dictate a relationship between the various embodiments and/or configurations discussed.

Systems and methods and/or processes according to one or more aspects of the present disclosure may be used or performed in connection with well construction at a well site, such as construction of a wellbore to obtain hydrocarbons (e.g., oil and/or gas) from a formation, including drilling the wellbore. For example, some aspects may be described in the context of drilling a wellbore in the oil and gas industry. One or more aspects of the present disclosure may be used in other systems. Construction of a wellbore, or operations of other systems, can be implemented using, among other things, control of various equipment by various equipment controllers. Additionally, visual monitoring the construction or other operations can be implemented using imaging devices, for example. Further, personnel at the well site or other site may be assigned user devices through which those personnel communicate and/or perform other tasks. Each of the equipment controllers, imaging devices, user devices, and other example devices can be communicatively coupled to a physical network, such as a single physical network, in accordance with one or more aspects of the present disclosure.

Devices can be logically separated into different virtual networks in the network. For example, the virtual networks can generally be separated by types of systems for which the devices on the virtual network are used, such as control systems (e.g., including equipment controllers) or non-control systems (e.g., including imaging devices, telephones, user computers, printers, etc.). Hence, some virtual networks can be control virtual networks, and other virtual networks can be non-control virtual networks. Additionally, the virtual networks can be separated by types of communications within the virtual networks, such as real-time communications or non-real-time communications. Different communication protocols can be used on the different virtual networks, for example.

Gateways, firewalls, and switches can be implemented in the network on one or more appropriate network appliances or other devices. The switches can be configured to implement the various virtual networks. The gateways can translate communications between different virtual networks and can implement a common communication bus for communications between different virtual networks. The firewalls can implement security rules for permitting communication between different virtual networks. Additionally, the gateways, firewalls, and switches may use a respective access list as a security mechanism for permitting or prohibiting a communication.

In some examples, communications between various systems, such as between control and non-control systems and/or devices, and/or between various networks implementing different protocols, such as real-time and non-real-time communications, may be enabled without affecting construction of a wellbore or other operations. Various security measures may effectively isolate various virtual networks and provide security from third-party hacking, in some examples. Further, some examples may provide for central monitoring and logging of operations of devices on the physical network, which may enable overall visibility and correlation of events across multiple systems.

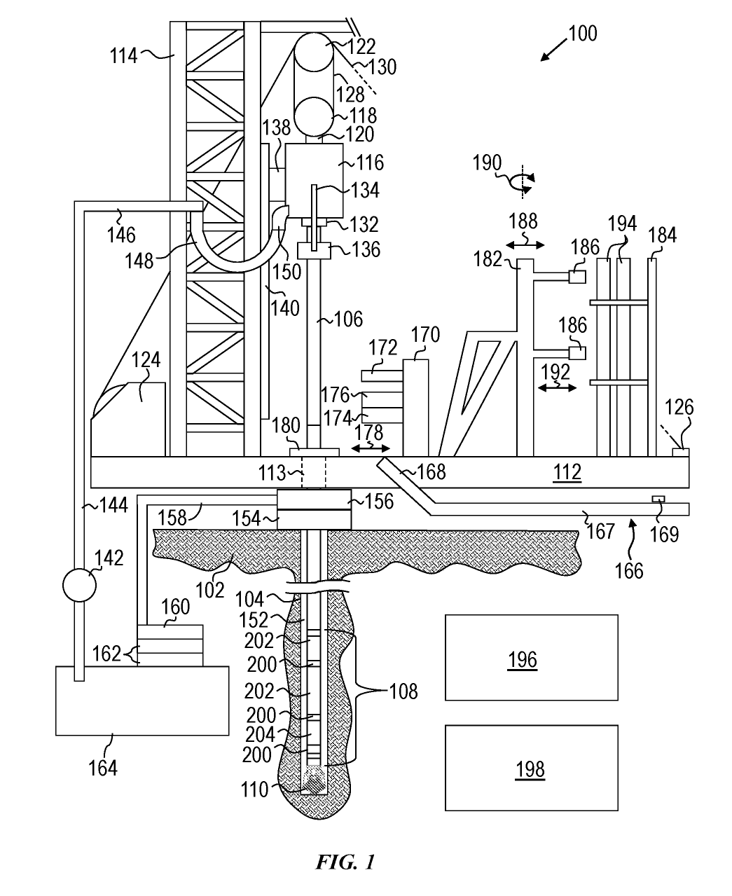

FIG. 1 is a schematic view of at least a portion of an example implementation of a well construction system 100 operable to drill a wellbore 104 into one or more subsurface formations 102 at a well site in accordance with one or more aspects of the present disclosure. A drillstring 106 penetrates the wellbore 104 and includes a bottom hole assembly (BHA) 108 that comprises or is mechanically and hydraulically coupled to a drill bit 110. The well construction system 100 includes a mast 114 (at least a portion of which is depicted in FIG. 1) extending from a rig floor 112 that is erected over the wellbore 104. A top drive 116 is suspended from the mast 114 and is mechanically coupled to the drillstring 106. The top drive 116 provides a rotational force to drive rotational movement of the drillstring 106, such as to advance the drillstring 106 into the formation 102 to form the wellbore 104.

The top drive 116 is suspended from the mast 114 via hoisting equipment. The hoisting equipment includes a traveling block 118 with a hook 120, a crown block 122, a drawworks 124, a deadline anchor 126, a supply reel (not depicted), and a drill line 128 with a deadline 130 (a portion of which is shown in phantom). The hook 120 of the traveling block 118 mechanically couples with the top drive 116, although other means for coupling the traveling block 118 with the top drive 116 are also within the scope of the present disclosure. The crown block 122 is suspended from, coupled with, and/or otherwise supported by the mast 114.

The drawworks 124 and the deadline anchor 126 are on and supported by the rig floor 112. The drill line 128 is supplied from the supply reel through the deadline anchor 126. The drill line 128 may be wrapped around and clamped at the deadline anchor 126 such that the drill line 128 that extends from the deadline anchor 126 to the crown block 122 is stationary during normal drilling operations, and hence, the portion of the drill line 128 that extends from the deadline anchor 126 to the crown block 122 is referred to as the deadline 130.

The crown block 122 and traveling block 118 comprise one or more pulleys or sheaves. The drill line 128 is reeved around the pulleys or sheaves of the crown block 122 and the traveling block 118. The drill line 128 extends from the crown block 122 to the drawworks 124. The drawworks 124 can comprise a drum, a prime mover (e.g., an engine or motor), a control system, and one or more brakes, such as a mechanical brake (e.g., a disk brake), an electrodynamic brake, and/or the like. The prime mover of the drawworks 124 drives the drum to rotate and reel in drill line 128, which in turn causes the traveling block 118 and top drive 116 to move upward. The drawworks 124 can reel out drill line 128 by a controlled rotation of the drum using the prime mover and control system, and/or by disengaging the prime mover (such as with a clutch) and disengaging and/or operating one or more brakes to control the release of the drill line 128. By unreeling drill line 128 from the drawworks 124, the traveling block 118 and top drive 116 may move downward.

Implementations within the scope of the present disclosure include land-based rigs, as depicted in FIG. 1, as well as offshore implementations. In offshore implementations, the hoisting equipment may also include a motion or heave compensator between the mast 114 and the crown block 122 and/or between the traveling block 118 and the hook 120, for example.

The top drive 116 includes a drive shaft 132, a pipe handling assembly 134 with an elevator 136, and various other components not shown in FIG. 1, such as a prime mover and a grabber. The drillstring 106 is mechanically coupled to the drive shaft 132 (e.g., with or without a sub saver between the drillstring 106 and the drive shaft 132). The prime mover drives the drive shaft 132, such as through a gearbox or transmission, to rotate the drive shaft 132 and, therefore, the drillstring 106, such as to advance the drillstring 106 into the formation 102 to form the wellbore 104. The pipe handling assembly 134 and elevator 136 permit the top drive 116 to handle tubulars (e.g., single, double, or triple stands of drill pipe and/or casing) that are not mechanically coupled to the drive shaft 132. The grabber includes a clamp that clamps onto a tubular when making up and/or breaking out a connection of a tubular with the drive shaft 132. A guide system (e.g., rollers, rack-and-pinion elements, and/or other mechanisms) includes a guide 140, affixed or integral to the mast 114, and portions 138 integral to or otherwise carried with the top drive 116 up and down the guide 140. The guide system may provide torque reaction, such as to prevent rotation of the top drive 116 while the prime mover is rotating the drive shaft 132. The guide system may also or instead aid in maintaining alignment of the top drive 116 with an opening 113 in the rig floor 112 through which the drillstring 106 extends.

A drilling fluid circulation system circulates oil-based mud (OBM), water-based mud (WBM), and/or other drilling fluid to the drill bit 110. A pump 142 delivers drilling fluid through, for example, a discharge line 144, a standpipe 146, and a rotary hose 148, to a port 150 of the top drive 116. The drilling fluid is then conducted through the drillstring 106 to the drill bit 110, exiting into the wellbore 104 via ports in the drill bit 110. The drilling fluid then circulates upward through an annulus 152 defined between the outside of the drillstring 106 and the wall of the wellbore 104. In this manner, the drilling fluid lubricates the drill bit 110 and carries formation cuttings up to the surface as the drilling fluid is circulated.

At the surface, the drilling fluid may be processed for recirculation. For example, the drilling fluid may flow through a blowout preventer 154 and a bell nipple 156 that diverts the drilling fluid to a return flowline 158. The return flowline 158 may direct the drilling fluid to a shale shaker 160 that removes at least large formation cuttings from the drilling fluid. The drilling fluid may then be directed to reconditioning equipment 162, such as may remove gas and/or finer formation cuttings from the drilling fluid. The reconditioning equipment 162 can include a desilter, a desander, a degasser, and/or other components.

After treatment by the reconditioning equipment 162, the drilling fluid may be conveyed to one or more mud tanks 164. Intermediate mud tanks may also be used to hold drilling fluid before and/or after the shale shaker 160 and/or various ones of the reconditioning equipment 162. The mud tank(s) 164 can include an agitator to assist in maintaining uniformity (e.g., homogeneity) of the drilling fluid contained therein. A hopper (not depicted) may be disposed in a flowline between the mud tank(s) 164 and the pump 142 to disperse an additive, such as caustic soda, in the drilling fluid.

A catwalk 166 can be used to convey tubulars from a ground level to the rig floor 112. The catwalk 166 has a horizontal portion 167 and an inclined portion 168 that extends between the horizontal portion 167 and the rig floor 112. A skate 169 may be positioned in a groove and/or other alignment means in the horizontal and inclined portions of the catwalk 166. The skate 169 can be driven along the groove by a rope, chain, belt, and/or other pulley system (not depicted), thereby pushing tubulars up the inclined portion 168 of the catwalk 166 to a position at or near the rig floor 112 for subsequent engagement by the elevator 136 of the top drive 116 and/or other pipe handling means. However, other means for transporting tubulars from the ground to the rig floor 112 are also within the scope of the present disclosure. One or more pipe racks may also adjoin the horizontal portion 167 of the catwalk 166, and may have a spinner unit and/or other means for transferring tubulars to the horizontal portion 167 of the catwalk 166 in a mechanized and/or automated manner.

An iron roughneck 170 is also disposed on the rig floor 112. The iron roughneck 170 comprises a spinning system 172 and a torque wrench comprising a lower gripper 174 and an upper gripper 176. The iron roughneck 170 is moveable (e.g., in a translation movement 178) to approach the drillstring 106 (e.g., for making up and/or breaking out a connection of the drillstring 106) and to move clear of the drillstring 106. The spinning system 172 applies low-torque spinning to threadedly engage or disengage a threaded connection between tubulars of the drillstring 106, and the torque wrench applies a higher torque to ultimately make up or initially break out the threaded connection.

Manual, mechanized, and/or automated slips 180 are also disposed on and/or in the rig floor 112. The drillstring 106 extends through the slips 180. In mechanized and/or automated implementations of the slips 180, the slips 180 can be actuated between open and closed positions. In the open position, the slips 180 permit advancement of the drillstring 106 through the slips 180. In the closed position, the slips 180 clamp the drillstring 106 to prevent advancement of the drillstring 106, including with sufficient force to support the weight of the drillstring 106 suspended in the wellbore 104.

To form the wellbore 104 (e.g., “make hole”), the hoisting equipment lowers the top drive 116, and thus the drillstring 106 suspended from the top drive 116, while the top drive 116 rotates the drillstring 106. During this advancement of the drillstring 106, the slips 180 are in the open position, and the iron roughneck 170 is clear of the drillstring 106. When the upper end of the tubular in the drillstring 106 that is made up to the top drive 116 nears the slips 180, the hoisting equipment ceases downward movement of the top drive 116, the top drive 116 ceases rotating the drillstring 106, and the slips 180 close to clamp the drillstring 106. The grabber of the top drive 116 clamps the upper portion of the tubular made up to the drive shaft 132. The drive shaft 132 is driven via operation of the prime mover of the top drive 116 to break out the connection between the drive shaft 132 and the drillstring 106. The grabber of the top drive 116 then releases the tubular of the drillstring 106, and the hoisting equipment raises the top drive 116 clear of the “stump” of the drillstring 106 extending upward from the slips 180.

The elevator 136 of the top drive 116 is then pivoted away from the drillstring 106 towards another tubular extending up through the rig floor 112 via operation of the catwalk 166. The elevator 136 and the hoisting mechanism are then operated to grasp the additional tubular with the elevator 136. The hoisting equipment then raises the additional tubular, and the elevator 136 and the hoisting equipment are then operated to align and lower the bottom end of the additional tubular to proximate the upper end of the stump.

The iron roughneck 170 is moved 178 toward the drillstring 106, and the lower gripper 174 clamps onto the stump of the drillstring 106. The spinning system 172 then rotates the suspended tubular to engage a threaded (e.g., male) connector with a threaded (e.g., female) connector at the top end of the stump. Such spinning continues until achieving a predetermined torque, number of spins, vertical displacement of the additional tubular relative to the stump, and/or other operational parameters. The upper gripper 176 then clamps onto and rotates the additional tubular with a higher torque sufficient to complete making up the connection with the stump. In this manner, the additional tubular becomes part of the drillstring 106. The iron roughneck 170 then releases the drillstring 106 and is moved 178 clear of the drillstring 106.

The grabber of the top drive 116 then grasps the drillstring 106 proximate the upper end of the drillstring 106. The drive shaft 132 is moved into contact with the upper end drillstring 106 and is rotated via operation of the prime mover to make up a connection between the drillstring 106 and the drive shaft 132. The grabber then releases the drillstring 106, and the slips 180 are moved into the open position. Drilling may then resume.

FIG. 1 also depicts a pipe handling manipulator (PHM) 182 and a fingerboard 184 disposed on the rig floor 112, although other implementations within the scope of the present disclosure may include one or both of the PHM 182 and the fingerboard 184 located elsewhere or excluded. The fingerboard 184 provides storage (e.g., temporary storage) of tubulars 194, such that the PHM 182 can be operated to transfer the tubulars 194 from the fingerboard 184 for inclusion in the drillstring 106 during drilling or tripping-in operations, instead of (or in addition to) from the catwalk 166, and similarly for transferring tubulars 194 removed from the drillstring 106 to the fingerboard 184 during tripping-out operations.

The PHM 182 includes arms and clamps 186 collectively operable for grasping and clamping onto a tubular 194 while the PHM 182 transfers the tubular 194 to and from the drillstring 106, the fingerboard 184, and the catwalk 166. The PHM 182 is movable in at least one translation direction 188 and/or a rotational direction 190 around an axis of the PHM 182. The arms of the PHM 182 can extend and retract along direction 192.

The tubulars 194 conveyed to the rig floor 112 via the catwalk 166 (such as for subsequent transfer by the top drive elevator 136 and/or the PHM 182 to the drillstring 106 and/or the fingerboard 184) may be single joints and/or double- or triple-joint stands assembled prior to being fed onto the catwalk 166. In other implementations, the catwalk 166 may include means for making/breaking the multi-joint stands.

The multi joint stands may also be made up and/or broken out via cooperative operation of two or more of the top drive 116, the drawworks 124, the elevator 136, the catwalk 166, the iron roughneck 170, the slips 180, and the PHM 182. For example, the catwalk 166 may position a first joint (drill pipe, casing, etc.) to extend above the rig floor 112 or another orientation where the joint can be grasped by the elevator 136. The top drive 116, the drawworks 124, and the elevator 136 may then cooperatively transfer the first joint into the wellbore 104, where the slips 180 may retain the first joint. The catwalk 166 may then position a second joint that will be made up with the first joint. The top drive 116, the drawworks 124, and the elevator 136 may then cooperatively transfer the second joint to proximate the upper end of the first joint extending up from the slips 180. The iron roughneck 170 may then make up the first and second joints to form a double stand. The top drive 116, the drawworks 124, the elevator 136, and the slips 180 may then cooperatively move the double stand deeper into the wellbore 104, and the slips 180 may retain the double stand such that an upper end of the second joint extends upward. If the contemplated drilling, casing, or other operations are to utilize tripe stands, the catwalk 166 may then position a third joint to extend above the rig floor 112, and the top drive 116, the drawworks 124, and the elevator 136 may then cooperatively transfer the third joint to proximate the upper end of the second joint extending up from the slips 180. The iron roughneck 170 may then make up the second and third joints to form a triple stand. The top drive 116 (or the elevator 136) and the drawworks 124 may then cooperatively lift the double or triple stand out of the wellbore 104. The PHM 182 may then transfer the stand from the top drive 116 (or the elevator 136) to the fingerboard 184, where the stand may be stored until retrieved by the PHM 182 for the drilling, casing, and/or other operations. This process of assembling stands may generally be performed in reverse to disassemble the stands.

A power distribution center 196 is also at the well site. The power distribution center 196 includes one or more generators, one or more AC-to-DC power converters, one or more DC-to-AC power inverters, one or more hydraulic systems, one or more pneumatic systems, the like, or a combination thereof. The power distribution center 196 can distribute AC and/or DC electrical power to various motors, pumps, or the like that are throughout the well construction system 100. Similarly, the power distribution center 196 can distribute pneumatic and/or hydraulic power throughout the well construction system 100. Components of the power distribution center 196 can be centralized in the well construction system 100 or can be distributed throughout the well construction system 100.

A control center 198 is also at the well site. The control center 198 houses one or more processing systems of a network of the well construction system 100. Details of the network of the well construction system 100 are described below. Generally, various equipment of the well construction system 100, such as the drilling fluid circulation system, the hoisting equipment, the top drive 116, the PHM 182, the catwalk 166, etc., can have various sensors and controllers to monitor and control the operations of that equipment. Additionally, the control center 198 can receive information regarding the formation and/or downhole conditions from modules and/or components of the BHA 108.

The BHA 108 can comprise various components with various capabilities, such as measuring, processing, and storing information. A telemetry device can be in the BHA 108 to enable communications with the control center 198. The BHA 108 shown in FIG. 1 is depicted as having a modular construction with specific components in certain modules. However, the BHA 108 may be unitary or select portions thereof may be modular. The modules and/or the components therein may be positioned in a variety of configurations throughout the BHA 108. The BHA 108 may comprise a measurement while drilling (MWD) module 200 that may include tools operable to measure wellbore trajectory, wellbore temperature, wellbore pressure, and/or other example properties. The BHA 108 may comprise a sampling while drilling (SWD) system comprising a sample module 202 for communicating a formation fluid through the BHA 108 and obtaining a sample of the formation fluid. The SWD system may comprise gauges, sensor, monitors and/or other devices that may also be utilized for downhole sampling and/or testing of a formation fluid. The BHA 108 may comprise a logging while drilling (LWD) module 204 that may include tools operable to measure formation parameters and/or fluid properties, such as resistivity, porosity, permeability, sonic velocity, optical density, pressure, temperature, and/or other example properties.

A person having ordinary skill in the art will readily understand that a drilling system may include more or fewer equipment than as described herein and/or depicted in the figures. Additionally, various equipment and/or systems of the example implementation of the well construction system 100 depicted in FIG. 1 may include more or fewer equipment. For example, various engines, motors, hydraulics, actuators, valves, or the like that were not described above and/or depicted in FIG. 1 may be included in other implementations of equipment and/or systems also within the scope of the present disclosure.

Additionally, the well construction system 100 of FIG. 1 may be implemented as a land-based rig or on an offshore rig. One or more aspects of the well construction system 100 of FIG. 1 may be incorporated in and/or omitted from a land-based rig or an offshore rig. Such modifications are within the scope of the present disclosure.

Even further, one or more equipment and/or systems of the well construction system 100 of FIG. 1 may be transferrable via a land-based movable vessel, such as a truck and/or trailer. As examples, each of the following equipment and/or systems may be transferrable by a separate truck and trailer combination: the mast 114, the PHM 182 (and associated frame), the drawworks 124, the fingerboard 184, the power distribution center 196, the control center 198, and mud tanks 164 (and associated pump 142, shale shaker 160, and reconditioning equipment 162), the catwalk 166, etc. Some of the equipment and/or systems may be collapsible to accommodate transfer on a trailer. For example, the mast 114, the fingerboard 184, the catwalk 166, and/or other equipment and/or systems may be telescopic, folding, and/or otherwise collapsible. Other equipment and/or systems may be collapsible by other techniques, or may be separable into subcomponents for transportation purposes.

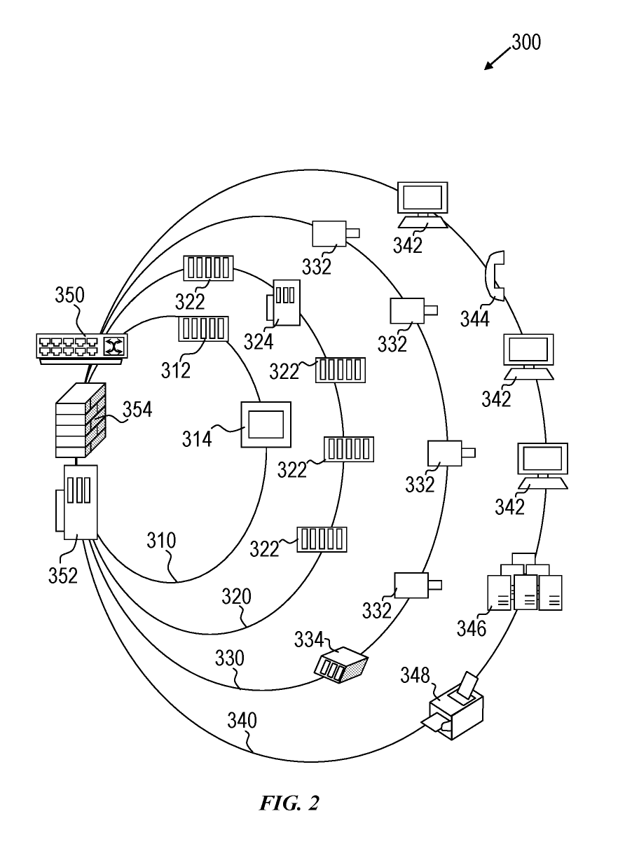

FIG. 2 is a schematic view of at least a portion of an example configuration of a network 300 according to one or more aspects of the present disclosure. The configuration of the network 300 illustrated in FIG. 2 can be, for example, a logical implementation. The implementation may be realized by configuring and operating virtual networks within the network 300. Generally, devices in a well construction system that use real-time communications can be in one or more virtual networks, while devices in the well construction system that use non-real-time communications can be in one or more different virtual networks. Real-time communications can be communications that are processed and/or transferred between a source and destination within a known period of time, whereas non-real time communications may not be processed and/or transferred between a source and a destination within a known period of time because of, for example, availability of resources, queuing of communications, prioritization schemes, etc. Additionally, devices used to control equipment of the well construction system (e.g., control devices) and other devices associated with such devices that are used to control equipment can be in one or more virtual networks, and devices that do not control equipment of the well construction system (e.g., non-control devices) can be in one or more different virtual networks.

The physical implementation of the network 300 in this example is a redundant ring topology, although in other examples the topology may be a bus topology, a star topology, a mesh topology, and/or other examples. In an example, the physical implementation may use fiber optics connections, such as for a redundant fiber ring, although other types of connections may be used. The physical implementation of the network 300 can communicatively couple each device of the well construction system, which are used in well construction operations.

In addition to control devices and non-control devices in the network 300, for example, one or more network appliances may be in the network 300 configured to implement one or more aspects described herein. Each network appliance may be a processing system, and as an example, a generic processing system is described below. Further, each network appliance may be a vertical device, e.g., the network appliance may be vertically scalable by adding resources, such as one or more processors and/or memory, to the network appliance, such as through use of a backplane. One of ordinary skill in the art will readily understand that a physical implementation of the network 300 and other example networks can vary, such as depending on devices of the well construction system and/or the network appliances that are used. Such variations are within the scope of the present disclosure.

The virtual networks may be virtual local area networks (VLANs). The virtual networks can be implemented, for example, according to the IEEE 802.1Q standard, another standard, and/or a proprietary implementation.

The example network 300 of FIG. 2 is separated into four virtual networks, although in other implementations, a different number and/or configuration of virtual networks may be used. The network 300 includes a first virtual network 310, a second virtual network 320, a third virtual network 330, and a fourth virtual network 340. The first virtual network 310 may be a subsystem control virtual network that implements real-time communications. The second virtual network 320 may be a main system control virtual network that implements real-time communications. The third virtual network 330 may be an imaging virtual network that implements non-real-time communications. The fourth virtual network 340 may be a user and telephone virtual network that implements non-real-time communications. In other example networks, some of the virtual networks may be omitted, combined together, and/or separated into multiple networks. For example, a main system control virtual network may be separated into multiple subsystem control virtual networks, and/or a user and telephone virtual network may be separated into a user virtual network and a telephone virtual network. Other virtual networks may also be included. The virtual networks 310, 320, 330, and 340 may each use a different communication protocol, may each use a same communication protocol, or a permutation therebetween. Example protocols include TCP/IP, UDP, PROFINET, EtherCAT, RAPInet, or the like.

The first virtual network 310 includes one or more equipment controller (EC) 312 and one or more human-machine interface (HMI) 314. The EC 312 can be, for example, a programmable logic controller (PLC), industrial computer, or other control device that is configured to control operations of one or more equipment of the well construction system. For example, the equipment can be equipment of a drilling fluid circulation system, a cementing system, a rig walk system, etc. The EC 312, when used to control equipment of a drilling fluid circulation system, can control valves, pumps, fluid reconditioning equipment, and/or the like. Further, the EC 312, as part of the drilling fluid circulation system, can receive sensor and/or status data from sensors and/or equipment, such as from tachometers of pumps, pressure gauges at various positions along drilling fluid flow lines, and other example sensors and equipment. Other subsystems can have different equipment, sensors, etc. that may permit different control and receipt of different sensor and/or status data, as one of ordinary skill in the art will readily understand. Such subsystems are within the scope of the present disclosure.

The HMI 314 may be, comprise, or be implemented by a processing system with a keyboard, a mouse, a touchscreen, a joystick, one or more control switches or toggles, one or more buttons, a track-pad, a trackball, an image/code scanner, a voice recognition system, a display device (such as a liquid crystal display (LCD), a light-emitting diode (LED) display, and/or a cathode ray tube (CRT) display), a printer, speaker, and/or other examples. The HMI 314 may permit entry of commands to the EC 312 on the first virtual network 310 and for visualization or other sensory perception of various data, such as sensor data, status data, and/or other example data.

The second virtual network 320 includes multiple ECs 322 and one or more historian 324. The ECs 322 can be, for example, a PLC, industrial computer, or other control device that is configured to control operations of one or more equipment of a main system of the well construction system. For example, the main system can include hoisting equipment, drillstring rotary mover equipment (such as a top drive and/or rotary table), an automated pipe handling manipulator, catwalk, etc. The ECs 322, when as a part of a main system, can control the speed and torque of the drillstring rotary mover equipment, a weight-on-bit (WOB), the transfer of tubulars in the well construction system, and/or other operations. Further, the ECs 322, as part of the main system, can receive sensor and/or status data from sensors and/or equipment, such as from tachometers of the drillstring rotary mover equipment and the drillstring, a WOB sensor, and other example sensors and equipment. A main system can have different equipment, sensors, etc. that may permit different control and receipt of different sensor and/or status data, as one of ordinary skill in the art will readily understand. Such systems are within the scope of the present disclosure.

The historian 324 can be, for example, a server device, a database device, or other example processing system that is configured to store and maintain sensor data, status data, and/or other example data. The historian 324 can access data available from the second virtual network 320 or another virtual network and store the data in the historian 324. The data may then be accessed by personnel to analyze operations of the well construction system.

The third virtual network 330 includes multiple imaging devices 332 and one or more imaging controller 334. The imaging devices 332 can be cameras, such as still photography cameras, video cameras, or the like, which may be operated as perpetually on, motion detection initiated, or the like. The imaging devices 332 may be part of a well site security system to capture images of intruders and/or may capture images of operations for analysis. The imaging controller 334 can control the operation of the imaging devices 332 and can store images (e.g., including video) generated by the imaging devices 332.

The fourth virtual network 340 includes user computers 342, one or more telephones 344, one or more server devices 346, and one or more printers 348. The user computers 342 can be desktop computers, laptop computers, tablets, mobile devices, or other processing systems. The telephone 344 can be a landline-base telephone, a voice over internet protocol (VoIP) telephone, wired or wireless telephone, the like, or a combination thereof. The server devices 346 can be a server device and/or processing system that enables distribution of resources in a client-server architecture. The printer 348 can be a known or future-developed printer.

The devices illustrated in the example virtual networks 310, 320, 330, and 340 of FIG. 2 are examples, and each virtual network can have different and/or fewer or more devices therein. One of ordinary skill in the art will readily understand such modifications, which are within the scope of the present disclosure.

The network 300 includes switches 350. The switches 350 may be throughout the network 300 and may be communicatively coupled to respective ones of various devices, such as ECs, HMIs, imaging devices, user computers, telephones, etc. Each of the switches 350 may be a network appliance communicatively coupled to another one or more devices by a physical communication medium, such as an Ethernet connection or the like. In some examples, the switches 350 are communication nodes on the redundant fiber ring, and other devices are communicatively coupled to the redundant fiber ring through the switches 350. The switches 350 are configured to logically separate different devices onto different virtual networks 310, 320, 330, and 340.

The network 300 includes gateways 352. The gateways 352 can be software implementations on network appliances in the network 300. The gateways 352 translate communications between one or more given devices and a common data bus in the network 300, which can enable communications between different virtual networks that communicate according to different communication protocols. For example, a gateway 352 can be implemented on a network appliance communicatively coupled between various devices and a switch 350. In the context of the illustration of FIG. 2 as an example, two or more of the ECs 312, 322 may use different communication protocols, and hence, one or more gateways 352 can be implemented communicatively coupled between a switch 350 and those two or more ECs 312, 322. In this example, the gateway 352 receives communications according to those different communication protocols from the two or more ECs 312, 322, translates those communications to a common communication protocol, and transmits the translated communications to the switch 350. With the switches 350 receiving communications according to a common protocol, the redundant fiber ring of the above examples can be a common data bus through which the devices can communicate. In some examples, the gateways 352 can translate communications to a Data Distribution Service (DDS) protocol, which implements publish-subscribe communications, wherein the gateways 352 implement respective brokers. In some examples, if a device is configured to communicate according to the common communication protocol without use of a gateway, a gateway can be omitted for that device.

The network 300 also includes firewalls 354. The firewalls 354 can be software implementations on network appliances in the network 300. The firewalls 354 provide security for communications between virtual networks 310, 320, 330, and 340. The firewalls 354 can permit or prohibit communications from one or more given devices to the common data bus in the network 300. The firewalls 354 can implement rules to permit or prohibit communications, such as rules based on the communication channel of the communication (e.g., source IP address, Application, Port, destination IP address, etc.). For example, a firewall 354 can be implemented on a network appliance communicatively coupled between a switch 350 and various devices. In the context of the illustration of FIG. 2 as an example, a firewall 354 can be implemented communicatively coupled between one or more of the imaging devices 332 and a respective switch 350. In this example, the firewall 354 receives communications from the one or more imaging devices 332, determines whether those communications are permitted, and if permitted, transmits communications to the switch 350, which can transmit the communications to the common data bus.

In some examples, a firewall 354 is implemented between the common data bus and devices that are not used to control well construction operations (e.g., non-control devices), and no firewall is implemented between the common data bus and devices that are used to control well construction operations (e.g., control devices). In the context of the example network 300 of FIG. 2, example control devices include the ECs 312 and 322 and the HMI 314, and example non-control devices include the historian 324, the imaging devices 332, imaging controller 334, user computers 342, telephones 344, server devices 346, and printer 348.

Further, each of the switches 350, gateways 352, and firewalls 354 can implement an access list that identifies which devices of the network 300 are permitted to communicate with each other. In some examples, if a communication is not identified as permitted on an access list, the communication is not permitted, and the access list acts as a security mechanism for prohibiting unauthorized communications. The access lists can therefore provide security for communications to and/or from control devices without encountering a potentially adverse processing speed of such communications by a firewall.

Functionality of the switches 350, gateways 352, and firewalls 354 can be distributed throughout the network 300 on various combinations of network appliances as may be appropriate for a given network topology. One of ordinary skill in the art will readily understand such modification, which is within the scope of the present disclosure.

Resources on the network appliances in the network 300, including switches 350, can be dedicated for a given type of communication. For example, a certain percentage of resources (e.g., processing capability) on various network appliances can be dedicated to communications from control devices. The percentage of resources that is dedicated can be based on an expected amount of communication traffic through the network appliance. Even further, the resources can be dedicated per virtual network for virtual networks that include control devices (e.g., control virtual network). Remaining resources of the network appliances can be made available to communications from non-control devices.

By dedicating resources on the network appliances, in some examples, communications from and between control devices can be deterministic—the timing of communications from and between control devices can be known within a limited amount of uncertainty. By dedicating resources, resources to process communications from control devices may be available whenever the communications occur, and real-time communications can be achieved.

Resources available for communications from non-control devices (e.g., resources that are not dedicated for communications from control devices) may, in some instances, be inadequate to process each communication initially upon receipt. For these communications, a quality of service (QoS) indicator may be used to prioritize the communications, and communications can be queued prior to processing based on the timing of the receipt of communications and the prioritization of the communications. A QoS can be implemented in accordance with the IEEE 802.1Q standard or another example technique. Queuing can render communications from non-control devices to be not deterministic.

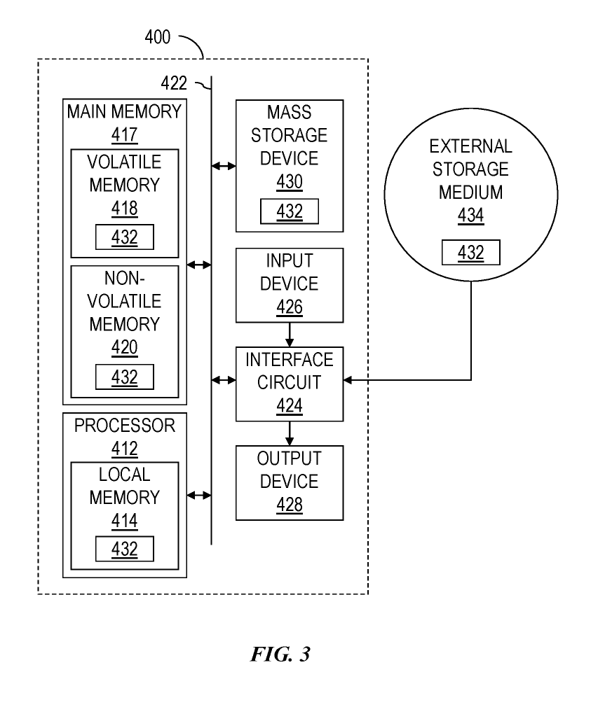

FIG. 3 is a schematic view of at least a portion of an example implementation of a generic processing system 400 according to one or more aspects of the present disclosure. The processing system 400 may execute example machine-readable instructions to implement at least a portion of one or more configuration or to implement at least a portion of one or more communications and/or control as described above. The processing system 400 may be implemented in a portion of one or more of the example devices described herein, such as a network appliance, an equipment controller (EC), a human-machine interface (HMI), an imaging device, an imaging controller, a user computer, a telephone, a server device, a printer, and/or other example devices. Various devices may include other components that are not expressly depicted in FIG. 3, and one of ordinary skill in the art will readily understand the presence and functionality of such components.

The processing system 400 may be or comprise, for example, one or more processors, controllers, special-purpose computing devices, server devices, personal computers, personal digital assistant (PDA) devices, telephones, network appliances, industrial computer, programmable logic controller, and/or other types of computing devices. Moreover, the functionality of a processing system 400 may be distributed across multiple devices and/or can be vertically scalable through a backplane in a single device, for example.

The processing system 400 comprises a processor 412 such as, for example, a general-purpose programmable processor. The processor 412 may comprise a local memory 414, and may execute program code instructions 432 present in the local memory 414 and/or in another memory device. The processor 412 may execute, among other things, machine-readable instructions or programs to implement the methods and/or processes described herein. The programs stored in the local memory 414 may include program instructions or computer program code that, when executed by an associated processor, enable communications and/or virtual networking as described herein. The processor 412 may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor 412 include one or more INTEL microprocessors, microcontrollers from the ARM and/or PICO families of microcontrollers, embedded soft/hard processors in one or more FPGAs, etc.

The processor 412 may be in communication with a main memory 417, such as via a bus 422 and/or other communication means. The main memory 417 may comprise a volatile memory 418 and a non-volatile memory 420. The volatile memory 418 may be, comprise, or be implemented by a tangible, non-transitory storage medium, such as random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 420 may be, comprise, or be implemented by a tangible, non-transitory storage medium, such as read-only memory, flash memory and/or other types of memory devices. One or more memory controllers (not shown) may control access to the volatile memory 418 and/or the non-volatile memory 420.

The processing system 400 may also comprise an interface circuit 424. The interface circuit 424 may be, comprise, or be implemented by various types of standard interfaces, such as an Ethernet interface, a universal serial bus (USB), a third generation input/output (3GIO) interface, a wireless interface, and/or a cellular interface, among other examples. The interface circuit 424 may also comprise a graphics driver card. The interface circuit 424 may also comprise a communication device such as a modem or network interface card to facilitate exchange of data with external computing devices via a network, such as via Ethernet connection, digital subscriber line (DSL), telephone line, coaxial cable, cellular telephone system, and/or satellite, among other examples.

One or more input devices 426 may be connected to the interface circuit 424. One or more of the input devices 426 may permit a user to enter data and/or commands for utilization by the processor 412. Each input device 426 may be, comprise, or be implemented by a keyboard, a mouse, a touchscreen, a track-pad, a trackball, an image/code scanner, a microphone, and/or a voice recognition system, among other examples. In some examples, the input device 426 can be an input circuit that receives digital signals and/or analog signals from equipment and/or sensors in a well construction system. In other examples, the input device 426 can be an image sensor, such as when the processing system 400 is an imaging device.

One or more output devices 428 may also be connected to the interface circuit 424. One or more of the output device 428 may be, comprise, or be implemented by a display device, such as a LCD, a LED display, and/or a CRT display, among other examples. One or more of the output devices 428 may also or instead be, comprise, or be implemented by a printer, speaker, and/or other examples. In some examples, the output device 428 can be an output circuit that outputs digital signals and/or analog signals to equipment in a well construction system to control operations of the equipment.

The processing system 400 may also comprise a mass storage device 430 for storing machine-readable instructions and data. The mass storage device 430 may be connected to the interface circuit 424, such as via the bus 422. The mass storage device 430 may be or comprise a tangible, non-transitory storage medium, such as a floppy disk drive, a hard disk drive, a compact disk (CD) drive, and/or digital versatile disk (DVD) drive, among other examples. The program code instructions 432 may be stored in the mass storage device 430, the volatile memory 418, the non-volatile memory 420, the local memory 414, and/or on a removable storage medium 434 (which may be connected to the interface circuit 424), such as a CD or DVD.

The modules and/or other components of the processing system 400 may be implemented in accordance with hardware (such as in one or more integrated circuit chips, such as an ASIC), or may be implemented as software or firmware for execution by a processor. In the case of firmware or software, the implementation can be provided as a computer program product including a computer readable medium or storage structure containing computer program code (i.e., software or firmware) for execution by the processor.

In view of the entirety of the present disclosure, including the figures and the claims, a person having ordinary skill in the art will readily recognize that the present disclosure introduces an apparatus comprising a communications network that includes a common data bus communicatively coupled to a plurality of control devices, a plurality of non-control devices, and a plurality of network appliances, wherein: the control devices are configured to control corresponding ones of a plurality of equipment components of a well construction system; one or more of the network appliances are configured to implement one or more gateways; one or more of the gateways are respectively disposed between the common data bus and a corresponding one or more of the control devices and/or a corresponding one or more of the non-control devices to translate communications to a common protocol for transmission on the common data bus; one or more of the network appliances is configured to implement one or more firewalls; and one or more of the firewalls are respectively disposed between the common data bus and a corresponding one or more of the non-control devices to permit or prohibit communications to be transmitted to the common data bus.

One or more of the network appliances may be configured to implement a plurality of virtual networks within the communications network. For example, a first virtual network of the virtual networks may include at least some of the control devices, and a second virtual network of the virtual networks may include at least some of the non-control devices and may not include the control devices. In such implementations, among others within the scope of the present disclosure, the network appliances may include switches configured to implement the plurality of virtual networks.

The network appliances may each be configured to implement an access list for permitting and prohibiting communications to the common data bus.

The common data bus may include a physical connection topology among switches, and the switches may be at least some of the network appliances. In such implementations, among others within the scope of the present disclosure, the physical connection topology may be a ring topology among the switches. For example, the physical connection topology may be a redundant fiber ring topology among the switches.

The control devices may be configured to transmit communications according to one or more real-time communication protocols, and the non-control devices may be configured to transmit communications according to one or more non-real-time communication protocols.

The network appliances may include resources dedicated for communications from the control devices that are not available for communications from the non-control devices, and the network appliances may include resources available for communications from the non-control devices. In such implementations, among others within the scope of the present disclosure, the network appliances may be configured to implement a prioritization and queuing scheme for communications from the non-control devices.

The present disclosure also introduces an apparatus comprising: (A) a plurality of equipment controllers each controlling operation of corresponding ones of a plurality of well construction equipment components; (B) a plurality of non-control devices each not operable to control operation of well construction equipment; and (C) a physical network including network appliances communicatively coupled to the equipment controllers and the non-control devices, wherein: (i) the physical network includes a common data bus; (ii) one or more gateways are implemented via one or more of the network appliances and translate communications to a common protocol for transmission on the common data bus, wherein the equipment controllers and the non-control devices are each communicatively coupled with the common data bus via at least one corresponding one of the one or more gateways; and (iii) one or more firewalls are implemented via one or more of the network appliances and control which communications are transmitted to the common data bus, wherein the non-control devices are each communicatively coupled with the common data bus via at least one corresponding one of the one or more firewalls, and wherein no firewall is communicatively disposed between the common data bus and the equipment controllers.

One or more of the network appliances may implement a plurality of virtual networks. For example, a first virtual network of the virtual networks may include at least some of the equipment controllers, and a second virtual network of the virtual networks may include at least some of the non-control devices and may not include the equipment controllers. In such implementations, among others within the scope of the present disclosure, the network appliances may include switches that implement the plurality of virtual networks.

One or more of the network appliances may each implement an access list governing control of which communications are transmitted to the common data bus.

The physical network may include a physical connection topology among switches, the switches may be at least some of the network appliances, and the physical connection topology and switches may form at least part of the common data bus. The physical connection topology may be a ring topology among the switches. For example, the physical connection topology may be a redundant fiber ring topology among the switches.

The equipment controllers may transmit communications according to one or more real-time communication protocols, and the non-control devices may transmit communications according to one or more non-real-time communication protocols.

The network appliances may include resources dedicated for communications from the equipment controllers that are not available for communications from the non-control devices, and the network appliances may include resources available for communications from the non-control devices. In such implementations, among others within the scope of the present disclosure, the network appliances may implement a prioritization and queuing scheme for communications from the non-control devices.

The present disclosure also introduces a method comprising operating a communications network, wherein the communications network comprises a common data bus communicatively coupled to a plurality of network appliances, a plurality of non-control devices, and a plurality of control devices configured to at least partially control corresponding ones of a plurality of components of equipment of a well construction system, and wherein operating the communications network comprises: (A) operating one or more gateways on one or more of the network appliances, including: (i) translating communications from the control devices and non-control devices to a common protocol; and (ii) transmitting the translated communications towards the common data bus; and (B) operating one or more firewalls on one or more of the network appliances, including: (i) determining whether to permit communications from the non-control devices to be transmitted to the common data bus; and (ii) transmitting the permitted communications towards the common data bus.

Operating the communications network may further comprise operating one or more switches on one or more of the network appliances. Operating the one or more switches may include operating a plurality of virtual networks within the communications network. For example, a first virtual network of the virtual networks may include at least some of the control devices, and a second virtual network of the virtual networks may include at least some of the non-control devices and may not include the control devices.

Operating the communications network may further comprise operating one or more switches on one or more of the network appliances, wherein operating the one or more gateways and the one or more switches may include implementing an access list for permitting and prohibiting communications to the common data bus.

The common data bus may include a physical connection topology among switches, and the switches may be at least some of the network appliances. In such implementations, among others within the scope of the present disclosure, the physical connection topology may be a ring topology among the switches. For example, the physical connection topology may be a redundant fiber ring topology among the switches.

The control devices may transmit communications according to one or more real-time communication protocols, and the non-control devices may transmit communications according to one or more non-real-time communication protocols.

The network appliances may include resources dedicated for communications from the control devices that are not available for communications from the non-control devices, and the network appliances may include resources available for communications from the non-control devices. In such implementations, among others within the scope of the present disclosure, the network appliances may implement a prioritization and queuing scheme for communications from the one or more of the non-control devices.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. An apparatus comprising:
a communications network including a common data bus communicatively coupled to a plurality of control devices, a plurality of non-control devices, and a plurality of network appliances, wherein:
the control devices are configured to control corresponding ones of a plurality of equipment components of a well construction system;
one or more of the network appliances are configured to implement one or more gateways;
one or more of the gateways are respectively disposed between the common data bus and a corresponding one or more of the control devices and/or a corresponding one or more of the non-control devices to translate communications to a common protocol for transmission on the common data bus;
one or more of the network appliances is configured to implement one or more firewalls; and
one or more of the firewalls are respectively disposed between the common data bus and a corresponding one or more of the non-control devices to permit or prohibit communications to be transmitted to the common data bus.

2. The apparatus of claim 1 wherein:
one or more of the network appliances are configured to implement a plurality of virtual networks within the communications network;
a first virtual network of the virtual networks includes at least some of the control devices; and
a second virtual network of the virtual networks includes at least some of the non-control devices and does not include the control devices.

3. The apparatus of claim 2 wherein the network appliances include switches configured to implement the plurality of virtual networks.

4. The apparatus of claim 1 wherein the network appliances are each configured to implement an access list for permitting and prohibiting communications to the common data bus.

5. The apparatus of claim 1 wherein the common data bus includes a physical connection topology among switches, and wherein the switches are at least some of the network appliances.

6. The apparatus of claim 5 wherein the physical connection topology is a ring topology among the switches.

7. The apparatus of claim 1 wherein:
the control devices are configured to transmit communications according to one or more real-time communication protocols; and
the non-control devices are configured to transmit communications according to one or more non-real-time communication protocols.

8. The apparatus of claim 1 wherein:
the network appliances include resources dedicated for communications from the control devices that are not available for communications from the non-control devices; and
the network appliances include resources available for communications from the non-control devices.

9. The apparatus of claim 8 wherein the network appliances are configured to implement a prioritization and queuing scheme for communications from the non-control devices.

10. An apparatus comprising:
a plurality of equipment controllers each controlling operation of corresponding ones of a plurality of well construction equipment components;
a plurality of non-control devices each not operable to control operation of well construction equipment; and
a physical network including network appliances communicatively coupled to the equipment controllers and the non-control devices, wherein:
the physical network includes a common data bus;
one or more gateways are implemented via one or more of the network appliances and translate communications to a common protocol for transmission on the common data bus, wherein the equipment controllers and the non-control devices are each communicatively coupled with the common data bus via at least one corresponding one of the one or more gateways; and
one or more firewalls are implemented via one or more of the network appliances and control which communications are transmitted to the common data bus, wherein the non-control devices are each communicatively coupled with the common data bus via at least one corresponding one of the one or more firewalls, and wherein no firewall is communicatively disposed between the common data bus and the equipment controllers.

11. The apparatus of claim 10 wherein the network appliances include switches that implement a plurality of virtual networks;

12. The apparatus of claim 10 wherein:
the equipment controllers transmit communications according to one or more real-time communication protocols; and
the non-control devices transmit communications according to one or more non-real-time communication protocols.

13. The apparatus of claim 10 wherein the network appliances include resources dedicated for communications from the equipment controllers that are not available for communications from the non-control devices.

14. A method comprising:
operating a communications network, wherein the communications network comprises a common data bus communicatively coupled to a plurality of network appliances, a plurality of non-control devices, and a plurality of control devices configured to at least partially control corresponding ones of a plurality of components of equipment of a well construction system, and wherein operating the communications network comprises:
operating one or more gateways on one or more of the network appliances, including:
translating communications from the control devices and non-control devices to a common protocol; and
transmitting the translated communications towards the common data bus; and
operating one or more firewalls on one or more of the network appliances, including:
determining whether to permit communications from the non-control devices to be transmitted to the common data bus; and
transmitting the permitted communications towards the common data bus.

15. The method of claim 14 wherein operating the communications network further comprises operating one or more switches on one or more of the network appliances, wherein:
operating the one or more switches includes operating a plurality of virtual networks within the communications network;
a first virtual network of the virtual networks includes at least some of the control devices; and
a second virtual network of the virtual networks includes at least some of the non-control devices and does not include the control devices.

16. The method of claim 14 wherein operating the communications network further comprises operating one or more switches on one or more of the network appliances, and wherein operating the one or more gateways and the one or more switches includes implementing an access list for permitting and prohibiting communications to the common data bus.

17. The method of claim 14 wherein the common data bus includes a physical connection topology among switches, and wherein the switches are at least some of the network appliances.

18. The method of claim 14 wherein:
the control devices transmit communications according to one or more real-time communication protocols; and
the non-control devices transmit communications according to one or more non-real-time communication protocols.

19. The method of claim 14 wherein the network appliances include resources dedicated for communications from the control devices that are not available for communications from the non-control devices.

20. The method of claim 14 wherein the network appliances implement a prioritization and queuing scheme for communications from the one or more of the non-control devices.
